(19) United States
(12) Patent Application Publication
(10) Pub. No.: US 2022/0108001 A1
(43) Pub. Date: Apr. 7, 2022

(54) SYSTEM FOR DETECTING AND PREVENTING UNAUTHORIZED SOFTWARE ACTIVITY

(71) Applicant: WhiteBeam Security, Incorporated, Tallahassee, FL (US)

(72) Inventor: Nathan Nye, St. Johns, FL (US)

(73) Assignee: WhiteBeam Security, Incorporated, Tallahassee, FL (US)

(21) Appl. No.: 17/450,206

(22) Filed: Oct. 7, 2021

Related U.S. Application Data
(60) Provisional application No. 63/198,253, filed on Oct. 7, 2020.

(51) Int. Cl. G06F 21/44; G06F 8/61; G06F 9/54

(52) U.S. Cl. CPC G06F 21/44; G06F 9/54; G06F 8/61

(57) ABSTRACT

A method for preventing unauthorized software activity in an operating system environment including the steps of (1) intercepting a call to a requested application by a calling application running on the operating system environment; (2) determining whether the calling application is authorized or unauthorized to make the call; (3) determining whether the requested application is authorized or unauthorized; (4) processing the call only if the calling application is authorized to make the call and the requested application is authorized; and (5) rejecting the call if the calling application is unauthorized to make the call or the requested application is unauthorized.

### RELATED APPLICATIONS

This application claims priority under 35 U.S.C. § 119(e) of U.S. Provisional Patent Application Ser. No. 63/198,253 (Attorney Docket No. 5476.00001) filed on Oct. 7, 2020 and titled SYSTEM FOR DETECTING AND PREVENTING UNAUTHORIZED SOFTWARE ACTIVITY. The content of this application is incorporated herein by reference.

### FIELD OF THE INVENTION

The present invention relates to systems and methods for ensuring only trusted applications execute on computer systems. More specifically, the present invention relates to a system and method for combining the features of an interposed library with a whitelist and hash values to ensure the execution of only authorized applications.

### BACKGROUND OF THE INVENTION

In today's networked environment, billions of Computer Systems are interconnected through public and private networks. Hackers continually seek to intrude into Computer Systems operated by governments, businesses, individuals, and others (collectively “Users”). It is desirable to have a computerized process that protects Computer Systems by detecting attempts to introduce and execute Malware, preventing such Malware from executing, and logging attempts to execute Malware for further analysis of threats to such Computer Systems.

Currently, there are known solutions for protecting systems from Malicious Activity. Some of these solutions use Blacklisting, but these solutions fail to meet the needs of the industry because new threats are continuously developed by Hackers and Blacklists quickly become dated. The need to prevent outdated Blacklists imposes a requirement of continuous updates to the system. Other solutions attempt to use Whitelisting, but these solutions are similarly unable to meet the needs of the industry because the Whitelist itself is vulnerable to Attacks when it is not secured by cryptographic methods. Still other solutions seek only to detect and report Attacks, but these solutions also fail to meet industry needs because they do not include the capability to stop an Attack in progress.

Many currently available solutions are implemented in software that must be specially modified for each computing Environment in which it operates. For example, different versions of a solution must be maintained for Windows and Linux Environments. Further, some solutions require different versions of their code for each variation of an operating Environment in which they operate. As a result, the solutions can be difficult for industry to use in typical commercial settings where not all Computer Systems may run the same version of a given Operating System.

Many currently available solutions are implemented in software that changes essential aspects of the computing Environment in which it operates. For example, some solutions for Linux systems require modification of the Linux Kernel. As a result, industry may be vulnerable to delays in implementation that can leave systems unprotected.

There exists a need for a solution that detects Malicious Activity, securely reports such activity, and prevents execution of the associated Malware.

There exists a need for a solution able to run in a myriad of operating Environments, including multiple versions of the leading Operating Systems, without modification or customization.

There exists a need for a solution that does not require modifications to the Kernel.

There exists a need for a solution that is resistant to attempts to evade, disable, or circumvent the computerized process and defeat its protective qualities.

The disclosed system and method advantageously fills these needs by protecting Computer Systems through detecting attempts to execute Malware, preventing execution of Malware, and providing logs or notices to authorized Users concerning attempts to execute Malware.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to system and method for preventing unauthorized software activity in an operating system environment. The method includes the steps of (1) intercepting a call to a requested application by a calling application running on the operating system environment; (2) determining whether the calling application is authorized or unauthorized to make the call; (3) determining whether the requested application is authorized or unauthorized; (4) processing the call only if the calling application is authorized to make the call and the requested application is authorized; and (5) rejecting the call if the calling application is unauthorized to make the call or the requested application is unauthorized.

In one embodiment, a dynamic linker may intercept the call.

The method may include the step of recording the rejection of the call in a log file, which may be encrypted and/or transmitted to a secure server.

The method may include the step of installing a special purpose shared library in the operating system environment. The special purpose shared library may be adapted to intercept the call of the calling application and the special purpose library may interposed between the calling application and the requested application.

The method may include the step of assembling a whitelist, which may include (1) at least one indication of whether the calling application is authorized to call the requested application and (2) at least one verified hash of the requested application if the requested application is authorized

The calling application may be authorized only if the indication of whether the calling application is authorized to call the requested application is positive and the calling application may be unauthorized if the indication of whether the calling application is authorized to call the requested application is not positive.

The method may include the step of calculating at least one hash of the requested application. The calculated hash may be compared to the verified hash. The requested application may be authorized if the calculated hash is equal to the verified hash and the requested application may be unauthorized if the calculated hash is not equal to the verified hash.

In one embodiment, the method may include the steps of (1) installing a special purpose shared library interposed between a calling application and a requested application in the operating system environment, the special purpose shared library may be adapted to intercept a call of the calling application; (2) assembling a whitelist, which may include (a) at least one indication of whether the calling application is authorized to call the requested application, and (b) at least one verified hash of the requested application if the requested application is authorized; (3) intercepting the call to the requested application by the calling application running on the operating system environment; (4) determining whether the calling application is authorized or unauthorized to make the call, wherein the calling application is authorized only if the indication of whether the calling application is authorized to call the requested application is positive and the calling application is unauthorized if the indication of whether the calling application is authorized to call the requested application is not positive; (5) calculating at least one hash of the requested application; (6) comparing the calculated hash of the requested application to the verified hash of the requested application; (7) determining whether the requested application is authorized or unauthorized wherein the requested application is authorized if the calculated hash is equal to the verified hash and the requested application is unauthorized if the calculated hash is not equal to the verified hash; (8) processing the call only if the calling application is authorized to make the call and the requested application is authorized; and (9) rejecting the call if the calling application is unauthorized to make the call or the requested application is unauthorized.

### BRIEF DESCRIPTION OF THE DRAWINGS

Some embodiments of the present invention are illustrated as an example and are not limited by the figures of the accompanying drawings, in which like references may indicate similar elements.

FIG. 1 is a block diagram of a system for preventing unauthorized software activity in an operating system environment according to an embodiment of the present invention.

FIG. 2 is a flow chart of a method for preventing unauthorized software activity in an operating system environment according to an embodiment of the present invention.

FIG. 3 is a flow chart of a method for preventing unauthorized software activity in an operating system environment according to an embodiment of the present invention.

FIGS. 4A-C are a flow chart of a method for preventing unauthorized software activity in an operating system environment according to an embodiment of the present invention.

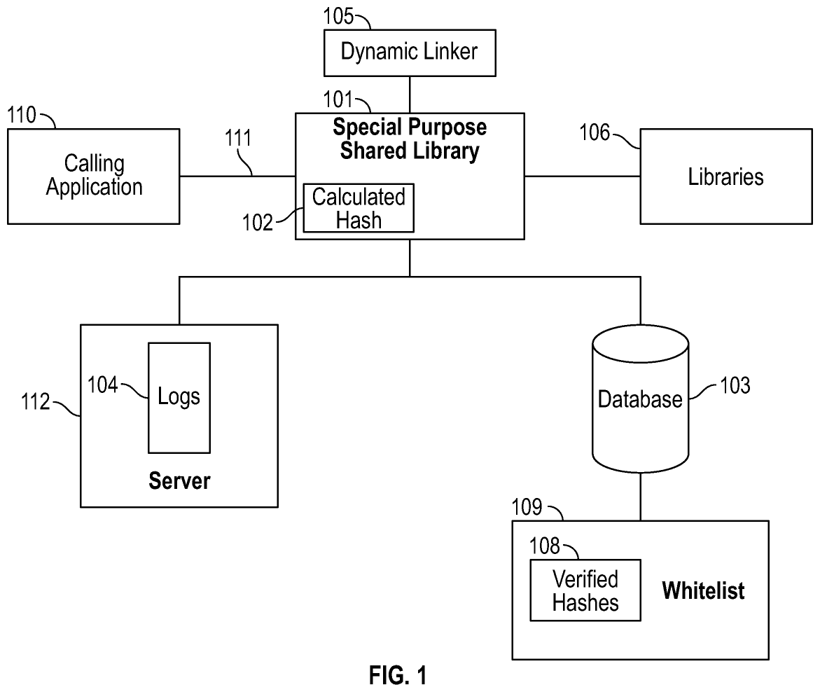

### DEFINITIONS

As used throughout this document, including in the claims, whether or not capitalized, the terms defined below have the meanings specifically set forth below.

“Application” means programs or scripts and program or script components (by way of example, but not as a limitation, libraries, library functions, configuration files, application data, or the like) that perform or enable the performance of work on a Computer System.

“Attack” means an attempt to disrupt, disable, destroy, or maliciously control a computing Environment or infrastructure; or destroying the integrity of data or stealing controlled information.

“Blacklist” means a list of Applications and various aspects of each Application that are prohibited from being active on a Computer System.

“Blacklisting” is the set of procedures used to create, manage, and enforce a Blacklist. In typical implementations, a Blacklist is used to limit what Applications may NOT run on a Computer System and ONLY Applications on the Blacklist are prohibited from executing on the Computer System. Contrast this with Whitelist.

“Computer System” means a combination of hardware and Operating System software that provides the capability to receive input, process data, and create information for storage or output. Throughout this document, Computer System includes any device that provides these capabilities whether or not such device would be conventionally recognized as a computer system. For example, and not as a limitation, embedded systems, devices in the “Internet of Things”, network routers, hypervisors, and other networked equipment, are included in the definition of Computer Systems.

“Dynamic Linking” means the process of using external, executable subroutines at Application runtime. Such subroutines are often part of the Operating System but may also be auxiliary files from other sources. Some such subroutines, by way of example and not limitation, include “dynamic link libraries” or .DLL files in Windows as well as “shared libraries” and “shared objects” or .SO files in Linux and other Unix-like Environments.

“Hash” means a cryptographic method that provides a reliable unique value for a binary input stream such as files, certificates, or passwords. Once calculated, a Hash can be used to confirm the authenticity of a file, user, or other resource.

“Hacker” means an unauthorized user who attempts to or gains access to a Computer System. A Hacker may mean, depending on the context, a person, a group of people, an entity or other organization, or an automated process.

“Incident” means Malicious Activity has been attempted and detected.

“Kernel” means the program, or programs, that constitute the central ring of an Operating System. The Kernel provides basic services for all other parts of the Operating System, which typically includes memory management, process management, file management and input/output (I/O) management (i.e., accessing the peripheral devices). These basic services are requested from the Kernel by other parts of the Operating System or by Applications.

“Library Interposition” means utilizing a feature or features of an Environment to cause the Dynamic Linker to redirect calls made by an Application to system or custom shared libraries (collectively “Operating System Libraries”) to a special purpose shared library.

“Libraries” take various forms in Computer Systems and may include, for example and not as a limitation, configuration data, pre-written code and subroutines, classes, values, or type specifications.

“Malicious Activity” means an attempt to run an Application or other code that is inserted into a Computer System without authorization from the system owner or operator, typically, but not exclusively, by a Hacker with the intent to steal or destroy data, run destructive or intrusive programs, or otherwise compromise the confidentiality, integrity, or availability of the victim's data, applications, or operating system. Malicious Activity is often attempted through software and such software is typically termed “Malware.”

“Operating System” means a computer program or combination of computer programs, implemented in either software, firmware, or a combination thereof, which acts as an intermediary between users of a computer and the computer hardware. The purpose of an Operating System is to provide an “Environment” in which a user can execute Applications (often described as “Userspace”). Some well-known Operating Systems include, by way of example, and not as a limitation, Windows 10 (Microsoft) and many previous versions of Windows, Linux as implemented in distributions provided by many developers, hypervisors, macOS(Apple), iOS (Apple), Android (Google) and embedded operating systems including, in some instances, “real time operating systems.”

“Shared Libraries” are files that are intended to be shared by executable files and further Shared Object files and may be, for example and not as a limitation, loaded into memory at load time or runtime by a linker.

“Whitelist” means a list of authorized Applications and various aspects of each authorized Application that are permitted to be active on a Computer System.

“Whitelisting” is the set of procedures used to create, manage, and enforce a Whitelist. In typical implementations, a Whitelist is used to limit what Applications may run on a Computer System and ONLY Applications on the Whitelist are permitted to execute on the Computer System. Contrast this with Blacklist.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a system and method for preventing unauthorized software activity in an operating system environment 100. In one embodiment, the method is able to prevent most, if not all, known methods to defeat its protective qualities, and it is capable of working with myriad Computer Systems and Operating Systems without modification.

The inventive system 100 may include a special purpose shared library 101, a whitelist 109 including hashes 108, and a database 103 adapted to store the whitelist 109. Among other things, the database 103 may be used to dynamically substitute functions to force the use of safe functions and/or to enhance the performance of the system. The inventive system may reside on a general-purpose computer and the inventive method may be performed by a general-purpose computer.

The inventive system provides a method for protecting Computer Systems from Malicious Activity. The system and method detect the presence of unauthorized software, prevent execution of unauthorized software, and provide logs 104 and/or notices to system operators notifying the operators of attempts to execute unauthorized software. This system and method may be used in a plurality of operating Environments. It should be further noted that the inventive system combines the techniques of (1) Library Interposition, (2) Whitelisting Applications known to be safe to execute, and (3) cryptographic methods to ensure the integrity of the referenced items on the Whitelist and to expose logs 104 and/or notices to authorized readers for analysis of attempts to execute unauthorized software.

The inventive method detects the presence of Malware, prevents execution of Malware, and provides log files 104 and/or notices to system operators about attempts to execute Malware. The method may include the step of defining a special purpose shared Library 101. The special purpose shared Library 101 may be defined such that it can be activated through an Operating System feature or features. The Operating System may be used to load the special purpose shared Library 101. The Dynamic Linker 105 may interpose the special purpose shared Library 101 between a calling application 110 and a requested Application 106, which may include programs, scripts, program components, script components, libraries, library functions, configuration files, application data, or the like. This interposing of the special purpose shared Library 101 ahead of requested applications106 may be referred to as Library Interposition. All calls from calling Applications 110 to requested Applications 106 may be intercepted by the special purpose shared Library 101 for resolution. When the calls are intercepted, it may be determined what calling Application 110 issued the call. The system may examine the whitelist 109 to determine if the calling Application 110 is authorized to call the requested application 106. The whitelist may include a indication of whether or not the requested application 106 may be called by the calling application 110. If the indication is positive, it may indicate that the calling application 110 is authorized. If the indication is negative, or not positive, it may indicate that the calling application 110 is unauthorized. If the calling Application 110 is unauthorized, the call may be rejected.

The special purpose shared library 101 may also calculate a hash 102 of the requested Application 106. The special purpose shared library 101 may compare the calculated Hash 102 of the requested Application 106to a verified hash 108 of the requested Application 106, which is included on a pre-defined Whitelist 109 saved to a database 103. If the calculated hash 102 of the requested Application 106 is equal to the verified hash 108 of the requested Application 106, the requested Application 106 may be authorized. If the calculated hash 102 and the verified hash 108 are not equal, the requested Application 106 may be unauthorized. If the requested Application 106 is authorized, the special purpose shared Library 101 may process the call 111 or pass it to the calling application 110 for resolution.

In the alternative, if the requested Application 110 is unauthorized, the call may be rejected and the requested Application 110 may be unable to continue execution.

When any call is rejected, whether due to an unauthorized calling application 110 or an unauthorized requested application 106, a log entry detailing the event may be entered in a log file 104, which may be encrypted and transmitted to a secure server 112. Such log files 104 can then be used to provide notifications of the event to authorized users or system administrators.

The integrity of the Whitelist 109, and the hashes 108 included thereon, may be maintained by use of cryptographic methods, which may include, but is not limited to, Hashing techniques.

In one embodiment, the inventive method may be implemented in the Rust programming language and a typical Linux operating Environment running on server hardware. The hardware may include a nonvolatile memory and processor.

The executable steps of one embodiment may include pre-operation steps, detection and prevention operation steps, and reporting operation steps.

One pre-operation step may include installing software in the operating Environment. By way of example, and not as a limitation, a special purpose shared Library 101 may be interposed between calling Applications 110 making Library calls and the system or between calling Applications 110 making Library calls and operating system Libraries 106 or all requested Applications 106 as the term Applications is defined and used throughout this document. Such interposition can be accomplished by several methods. By way of example, and not as a limitation, one possible approach is to set an Environment variable such as the glibc LD_PRELOAD or LD_AUDIT Environment variables or to supplement or modify the dynamic linker.

Another pre-operation step may include creating a whitelist 109 of Applications 110 in the Environment. Such a list may be created by an administrator of the system. The list may be loaded into a database 103 as a predefined list or provided to the system by other means known to those with skill in the art. The whitelist 109 may include a listing of authorized calling Applications 110, an indication of whether each calling Application 110 is authorized to call a plurality of requested Applications 106, and verified Hashes 108 for each of a plurality of requested Applications 106.

An additional pre-operation step may include computing the verified hashes 108. Hashes 108 of Applications 110 authorized to make or receive calls in the operating system environment may be computed for use during execution of the process. Upon computation of verified hashes 108, the hashes 108 may be added to the whitelist 109 and securely stored in the database 103. Additional calculated hashes 102 may be calculated during execution of the process. In one embodiment, the special purpose shared library 101 may include an algorithm to determine the calculated hash 102 of each requested application 106. During operation, the hash 102 of each requested Application 106 may be calculated and compared to the previously calculated, verified hash 108 of the requested Application 106, to determine if the requested Application is authorized.

After completion of all pre-operation steps, the system may be ready for normal operation and the operational steps may be executed. Operational steps may include detection of unauthorized calling Application 110 activity, prevention of execution of unauthorized requested Applications 106, and reporting, which may be written to a log file 104.

It is expected that whenever a calling Application 110 is running or being processed, the calling Application 110 will make calls to requested Applications 106. In one embodiment of the invention, the calling Application 110 is required to call the special purpose shared library 101 prior to the call to the requested Application 106 being processed. This may also be referred to as the special purpose shared library 101 intercepting the call of the calling application 110 to the requested application 106. One operational step may include the special purpose shared library 101 identifying the requested Application 110 and the calling Application 110. Once these are determined, the special purpose shared library 101 may query the indication included in the whitelist 109 to determine whether or not the calling application 110 is authorized to call the requested Application 110. Calling Applications 110 having positive indications that they may call the requested Application 106 are authorized calling Applications 110. Calling Applications 110 not having positive indications that they may call the requested Application 106 are unauthorized calling Applications 110. When a calling Application 110 makes a call to a requested Application 106, the call is intercepted by the interposed special purpose shared library 101. If the calling Application 110 is NOT authorized to call the requested application, the call will be rejected by the special purpose shared library 101 and an Incident record will be written to the log file 104, which may be stored in the database 103 and/or a server 112. However, if the call is authorized (the whitelist 109 includes a positive indication that the calling application 110 may call the requested Application 106), the Hash value of the requested Application 106 may be examined. The calculated Hash 102 value of the requested Application 106 may be compared to a verified hash 108 associated with the requested Application 106 and stored in the database 103. If the calculated hash 102 and verified Hash 108 do not match, the requested Application 106 will be determined to be unauthorized, the call will be rejected, and an Incident record will be written to a log file 104. If the calculated hash 102 and the verified hash 108 do match, the requested Application 106 will be determined to be authorized and the call will be resolved.

Only if the call to the requested Application 106 is determined by the special purpose shared library 101 to be both (1) initiated by a calling Application 110 authorized to call the requested Application 106 and (2) the calculated hash 102 and verified Hash 108 match will the special purpose shared Library 101 forward the call from the calling application 110 to the requested Application 106 and return control to the calling Application 110.

Virtually all methods of Attack introduced through network connections will be detected and prevented using these steps because almost every calling Application 110 makes calls to requested Applications 106. Many methods of Attack introduced in other modes will also be detected and prevented and because only calls from authorized and valid Applications 110 to authorized requested Applications 106 can be completed.

Whenever an Incident, including, but not limited to detection of an unauthorized action, mismatched hashes, unauthorized calling Application 110 or unauthorized requested Application 106 occurs, an Incident record may be recorded to a log file 104. Each log file 104 may be accessed with reporting tools known to those with skill in the art, including, but not limited to SQL queries. In some embodiments, a notification system may be linked to the log file 104 or database 103. The notification system may allow information about Incidents to be automatically pushed to authorized Users or system administrators.

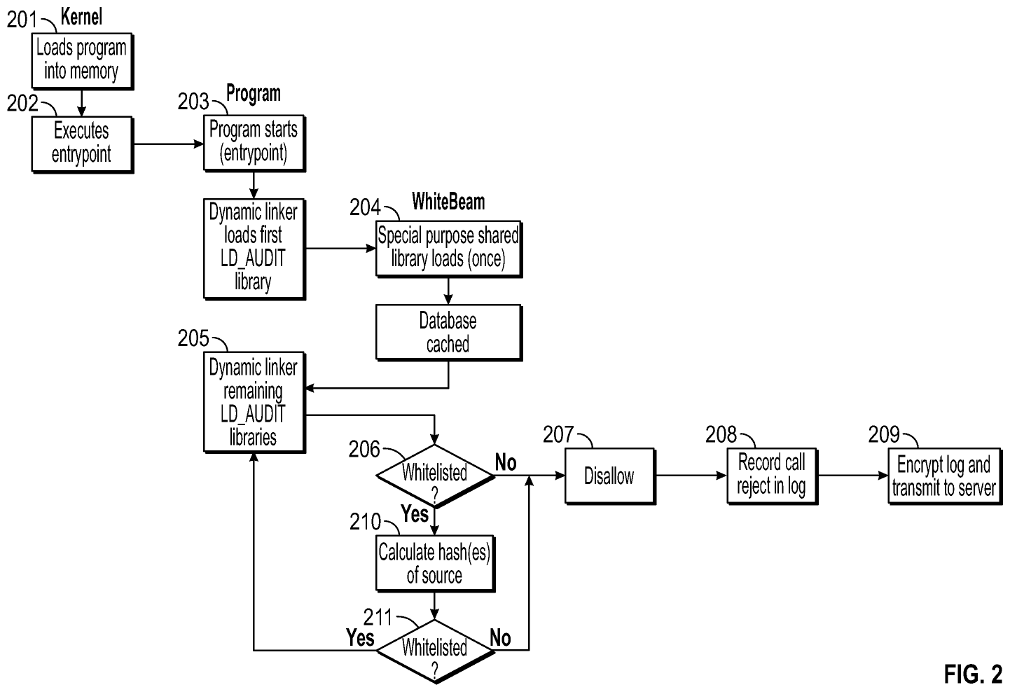

In one embodiment of the inventive method, as depicted in FIG. 2, the software embodying the method may be loaded into nonvolatile memory by the kernel of an operating system (step 201). The kernel may then execute an entry point (step 202). Upon execution of the entry point, the pre-operation steps may commence (step 203). The dynamic linker 105 may load the special purpose shared library 101, which may be stored in nonvolatile memory, into the database cache (step 204). The special purpose shared library 101 may include, or reference, a whitelist 109 of authorized calling applications 110 and one or more verified hash values 108 for each requested application 106. Upon a call by a calling application 110, the dynamic linker 105 may direct the call to the special purpose shared library 101 (step 205). The special purpose shared library 101 may determine whether or not the calling application 110 is indicated on the whitelist 109 (step 206) as authorized to call the requested Application 106. If the calling application 110 is not indicated on the whitelist 109 as authorized to call the requested Application 106, the call may be disallowed (step 207), the disallowed call may be recorded to a log file 104 (step 208), and the log file 104 may be encrypted and transmitted to a server 112, which may be secure (step 209). If the calling application 110 is indicated on the whitelist 109 as authorized to call the requested Application 106, the special purpose shared library 101 may calculate the hash 102 of the requested application 106 (step 210). The hash calculated in step 210 may be compared to the verified hash 108 associated with the requested application 106 and stored in the whitelist 109 (step 211). If the hash values match, the method may pass the call of the calling Application 110 onto the requested Application 106. If the hash values do not match, the call may be disallowed (step 207), the disallowed call may be recorded to a log file 104 (step 208), and the log file 104 may be encrypted and transmitted to a server 112, which may be secure (step 209).

In one embodiment, the requested application 106 may have more than one associated verified hash value 108. In such an embodiment, more than one calculated hash value 102 may be determined and compared to its respective verified hash value 108. In such an embodiment, the requested application 106 may be deemed authorized only if each of the verified hash values 108 associated with the requested application 106 equal each of the respective calculated hash values 102.

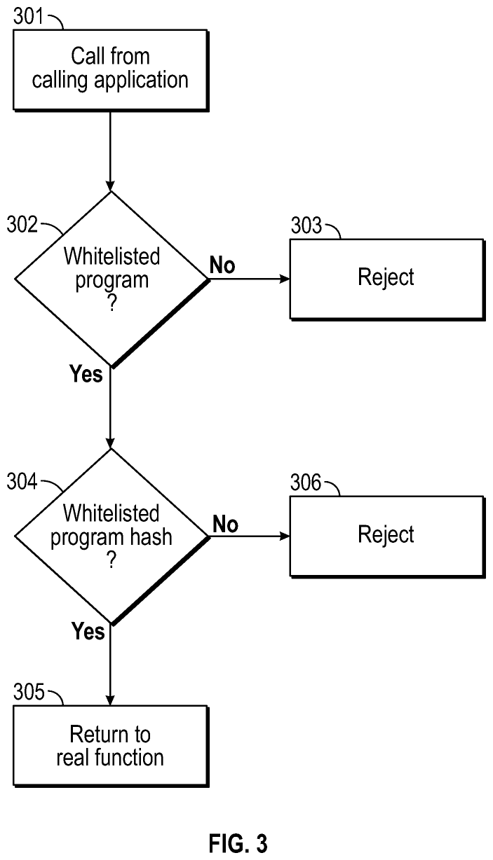

In one embodiment of the method, in which pre-operation steps have already been performed and as depicted in FIG.3, the special purpose shared library 101 may intercept every call from a calling application 110 to a requested application 106. Upon a call by a calling application 110 (step 301), the special purpose shared library 101 may determine whether or not the source application 110 is indicated on the whitelist 109 as authorized to call the requested Application 106 (step 302). If the calling application 110 is not indicated on the whitelist 109 as authorized to call the requested Application 106, the call may be disallowed (step 303). If the calling application 110 is indicated on the whitelist 109 as authorized to call the requested Application 106, the special purpose shared library 101 may calculate the hash 102 of the requested application 106 and compare it to the verified hash 108 associated with the requested application 106 and stored in the whitelist 109 (step 304). If the hash values match, the method may pass the call of the calling Application 110 onto the requested Application 106 (step 305). If the hash values do not match, the call may be disallowed (step 306).

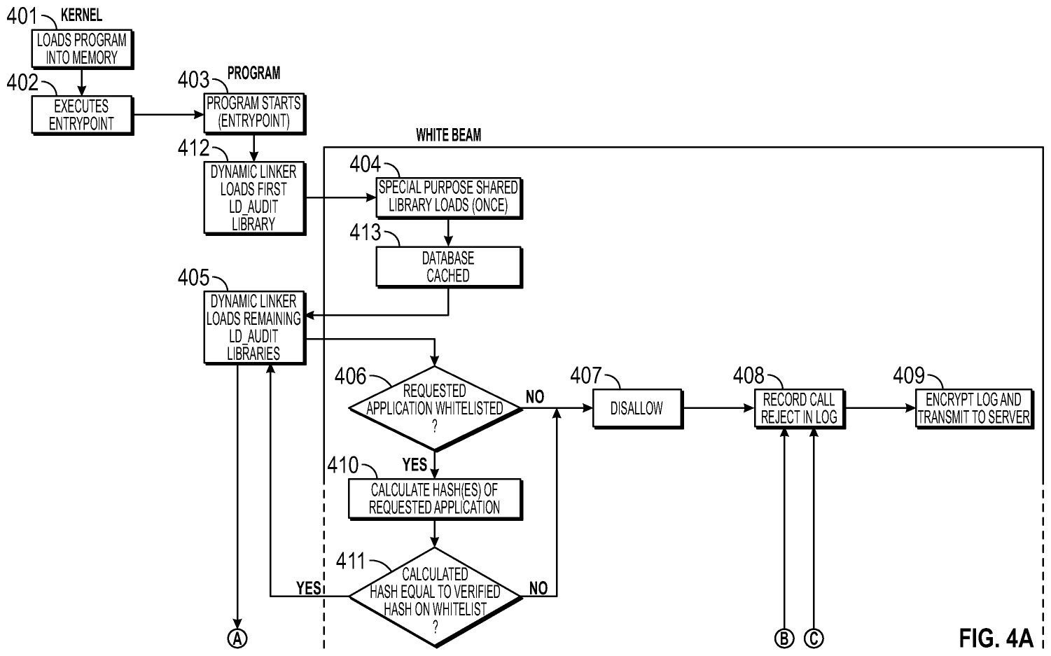

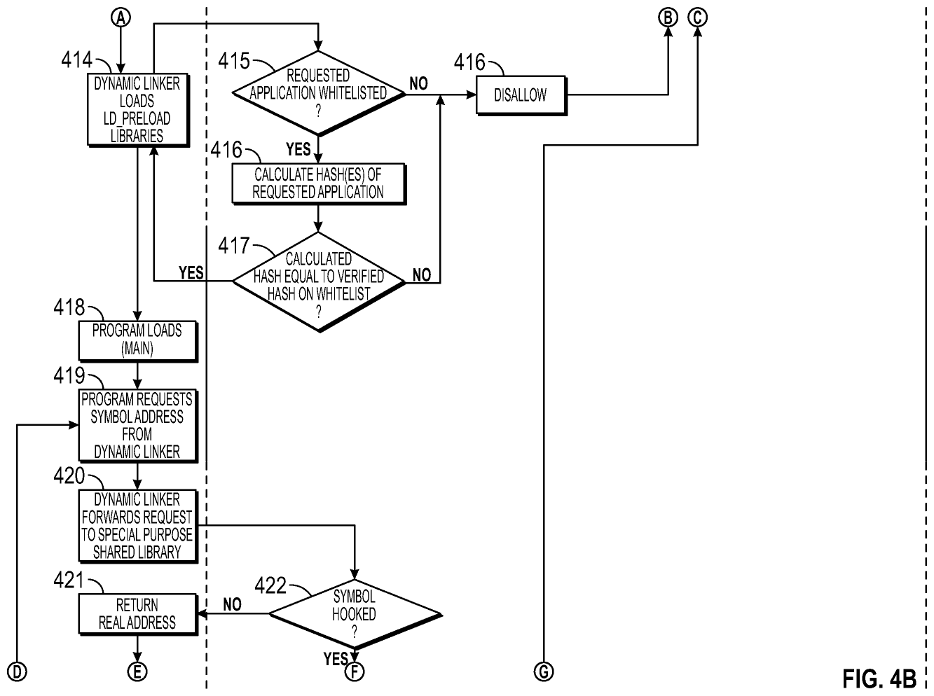

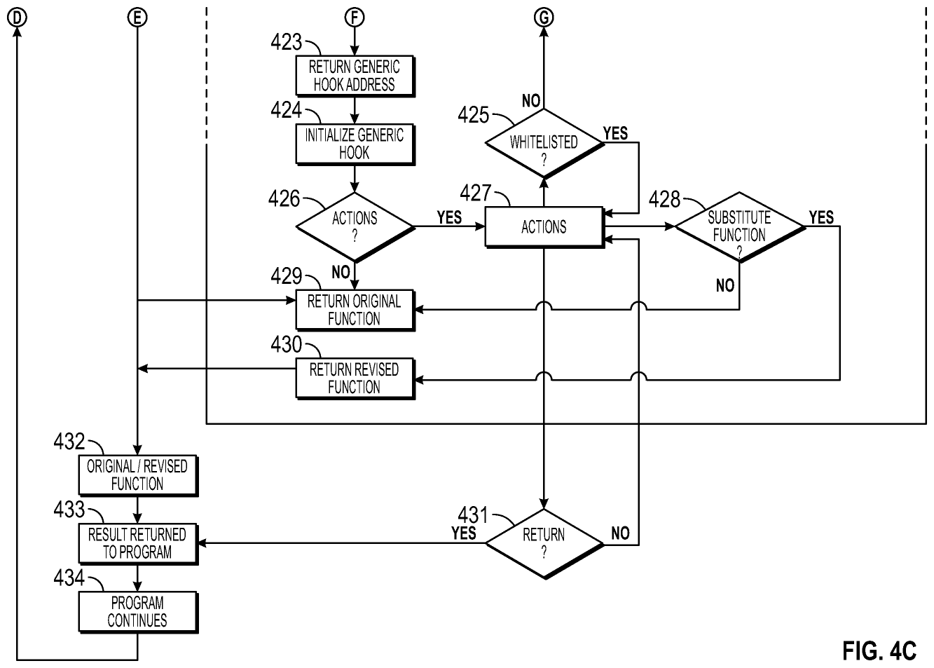

In one embodiment of the method, as depicted in FIG. 4, the software embodying the method may be loaded into nonvolatile memory by the kernel of an operating system (step 401). The kernel may then execute an entry point (step 402). Upon execution of the entry point, the pre-operation steps may commence (step 403). The dynamic linker 105 may load the first LD_AUDIT library (step 412). The first LD_AUDIT library may be the special purpose shared library 101, which may be loaded by the system (step 404). The special purpose shared library database may be cached (step 413). The dynamic linker may load additional LD_AUDIT libraries (step 405). Each time an additional LD_AUDIT library is loaded, step 406 may be executed. If step 406 completes successfully, steps 410 and 411 may also be executed. Upon loading of an LD_AUDIT library, other than the first LD_AUDIT library, which was the special purpose shared library 101, the system may treat the LD_AUDIT library as the requested application 110, the dynamic linker 105 may direct the call to the special purpose shared library 101. The special purpose shared library 101 may determine whether or not the calling application 110 is indicated on the whitelist 109 as authorized to call whatever application it is that is being called, which is referred to as the requested Application 106 (step 406). If the calling application 110 is not indicated on the whitelist 109 as authorized to call the requested Application 106, the calling application 110 may be deemed unauthorized and the call may be disallowed (step 407), the disallowed call may be recorded to a log file 104 (step 408), and the log file 104 may be encrypted and transmitted to a server 112, which may be secure (step 409).

If the calling application 110 is indicated on the whitelist 109 as authorized to call the requested application 106, the special purpose shared library 101 may calculate the hash 102 of the requested application 106 (step 410). The hash calculated in step 410 may be compared to the verified hash 108 associated with the requested application 106 and stored in the whitelist 109 (step 411). Note that if the requested application 106 is not authorized, there may not be a verified hash 108 present in the whitelist 109. In fact, in the case of an unauthorized requested application 106, there may not be any entry in the whitelist 109 corresponding to the requested application 106. In such an embodiment, the missing verified hash 108 is understood not to match the calculated hash 102. However, if the hash values compared in step 411 do match, the method may permit the requested Application 110 to load and the method may proceed to step 405. If the hash values do not match, the call may be disallowed (step 407), the disallowed call may be recorded to a log file 104 (step 408), and the log file 104 may be encrypted and transmitted to a server 112, which may be secure (step 409).

When all desired LD_AUDIT libraries are loaded, the method may proceed to step 414, in which the dynamic linker loads LD_PRELOAD libraries. This process may proceed similarly to loading the LD_AUDIT libraries. As shown in FIG. 4, the system may treat the LD_PRELOAD library as the requested application 110, the dynamic linker 105 may direct the call to the special purpose shared library 101. The special purpose shared library 101 may determine whether or not the calling application 110 is indicated on the whitelist 109 as authorized to call whatever application it is that is being called, which is referred to as the requested Application 106 (step 415). If the calling application 110 is not indicated on the whitelist 109 as authorized to call the requested Application 106, the calling application 110 may be deemed unauthorized and the call may be disallowed (step 416), the disallowed call may be recorded to a log file 104 (step 408), and the log file 104 may be encrypted and transmitted to a server 112, which may be secure (step 409).

If the calling application 110 is indicated on the whitelist 109 as authorized to call the requested application 106, the special purpose shared library 101 may calculate the hash 102 of the requested application 106 (step 416). The hash calculated in step 416 may be compared to the verified hash 108 associated with the requested application 106 and stored in the whitelist 109 (step 417). If the hash values compared in step 417 do match, the method may permit the requested Application 110 to load and the method may proceed to step 414. If the hash values do not match, the call may be disallowed (step 416), the disallowed call may be recorded to a log file 104 (step 408), and the log file 104 may be encrypted and transmitted to a server 112, which may be secure (step 409).

Continuing with FIG. 4, once the LD_PRELOAD libraries are loaded, the main program may load (step 418). In the course of execution, the program may request a symbol address from the dynamic linker (step 419). When the dynamic linker receives such a request, it will forward the request to the special purpose shared library 101 (step 420). The special purpose shared library 101 will determine if the symbol is hooked (step 422). If the symbol is not hooked, the real address will be returned (step 421), control will return to the original function (step 432), and the result will be returned to the program (step 433). If the symbol is hooked, the special purpose shared library 101 will return the generic hook address (step 423) and initialize a generic hook (step 424). The special purpose shared library 101 will then determine if actions are required (step 426). If actions are not required, the original function may be returned (step 429), control may be returned to the original function (step 432), and the result will be returned to the program (step 433). If actions are required, the special purpose shared library 101 will determine what actions are required (step 427). The whitelist will then be examined to determine if the program that requested the symbol address, the calling application 110 in this situation, is authorized to perform the operation (step 425). Step 425 may be repeated for each action that is to be performed. If the calling application 110 is not authorized, the rejection of the call may be recorded in the log file 104 (step 408) and the log file 104 may be encrypted and transmitted to a server 112, which may be secure (step 409). If the calling application 110 is authorized, the action may proceed and the method may return to step 427 to determine if there are more actions to perform. If there are more actions to be performed, the method may move to step 428 to determine if a substitute function is being executed. If a substitute function is being executed, the revised function may be returned (step 430), control may be returned to the revised function (step 432), and the result will be returned to the program (step 433). If there is no substitute function (step 428), the original function may be returned (step 429), control may be returned to the original function (step 432), and the result will be returned to the program (step 433). In each action, the action will determine whether or not to return (step 431). If the action does not return, it will continue to execute the actions (step 427). When the action does return, the result will be returned to the program (step 433) and the program will continue (step 434). The method will await another program request of a symbol address from the dynamic linker (step 419).

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

What is claimed is:

1. A method for preventing unauthorized software activity in an operating system environment comprising the steps of:
intercepting a call to a requested application by a calling application running on the operating system environment;
determining whether the calling application is authorized or unauthorized to make the call;
determining whether the requested application is authorized or unauthorized;
processing the call only if the calling application is authorized to make the call and the requested application is authorized; and
rejecting the call if the calling application is unauthorized to make the call or the requested application is unauthorized.

2. The method of claim 1 wherein a dynamic linker intercepts the call.

3. The method of claim 1 further comprising the step of recording the rejection of the call in a log file.

4. The method of claim 3 wherein the log file is encrypted and transmitted to a secure server.

5. The method of claim 1 further comprising the step of installing a special purpose shared library in the operating system environment.

6. The method of claim 5 wherein the special purpose shared library is adapted to intercept the call of the calling application and the special purpose library is interposed between the calling application and the requested application.

7. The method of claim 1 further comprising the step of assembling a whitelist.

8. The method of claim 7 wherein the whitelist comprises at least one indication of whether the calling application is authorized to call the requested application.

9. The method of claim 8 wherein the calling application is authorized only if the indication of whether the calling application is authorized to call the requested application is positive and the calling application is unauthorized if the indication of whether the calling application is authorized to call the requested application is not positive.

10. The method of claim 7 wherein the whitelist comprises at least one verified hash of the requested application if the requested application is authorized.

11. The method of claim 10 further comprising the step of calculating at least one hash of the requested application.

12. The method of claim 11 further comprising the step of comparing the calculated hash of the requested application to the verified hash of the requested application.

13. The method of claim 12 wherein the requested application is authorized if the calculated hash is equal to the verified hash and the requested application is unauthorized if the calculated hash is not equal to the verified hash.

14. A method for preventing unauthorized software activity in an operating system environment comprising the steps of:
installing a special purpose shared library interposed between a calling application and a requested application in the operating system environment, wherein the special purpose shared library is adapted to intercept a call of the calling application;
intercepting the call to the requested application by the calling application running on the operating system environment;
determining whether the calling application is authorized or unauthorized to make the call;
determining whether the requested application is authorized or unauthorized;
processing the call only if the calling application is authorized to make the call and the requested application is authorized; and
rejecting the call if the calling application is unauthorized to make the call or the requested application is unauthorized.

15. The method of claim 14 further comprising the step of assembling a whitelist comprising at least one indication of whether the calling application is authorized to call the requested application.

16. The method of claim 15 wherein the calling application is authorized only if the indication of whether the calling application is authorized to call the requested application is positive and the calling application is unauthorized if the indication of whether the calling application is authorized to call the requested application is not positive.

17. The method of claim 15 wherein the whitelist further comprises at least one verified hash of the requested application if the requested application is authorized.

18. The method of claim 17 further comprising the steps of:
calculating at least one hash of the requested application; and
comparing the calculated hash of the requested application to the verified hash of the requested application.

19. The method of claim 18 wherein the requested application is authorized if the calculated hash is equal to the verified hash and the requested application is unauthorized if the calculated hash is not equal to the verified hash.

20. A method for preventing unauthorized software activity in an operating system environment comprising the steps of:
installing a special purpose shared library interposed between a calling application and a requested application in the operating system environment, wherein the special purpose shared library is adapted to intercept a call of the calling application;
assembling a whitelist comprising:
at least one indication of whether the calling application is authorized to call the requested application, and
at least one verified hash of the requested application if the requested application is authorized;
intercepting the call to the requested application by the calling application running on the operating system environment;
determining whether the calling application is authorized or unauthorized to make the call, wherein the calling application is authorized only if the indication of whether the calling application is authorized to call the requested application is positive and the calling application is unauthorized if the indication of whether the calling application is authorized to call the requested application is not positive;
calculating at least one hash of the requested application;
comparing the calculated hash of the requested application to the verified hash of the requested application;
determining whether the requested application is authorized or unauthorized wherein the requested application is authorized if the calculated hash is equal to the verified hash and the requested application is unauthorized if the calculated hash is not equal to the verified hash;
processing the call only if the calling application is authorized to make the call and the requested application is authorized; and
rejecting the call if the calling application is unauthorized to make the call or the requested application is unauthorized.
